(19) United States
(12) Patent Application Publication
(10) Pub. No.: US 2002/0002060 A1
(43) Pub. Date: Jan. 3, 2002

(54) MULTI-APPLICATION COMMUNICATION DEVICE

(76) Inventors: MONA SINGH, CARY, NC (US); MICHAEL FEHNEL, FUQUAY-VARINA, NC (US)

Correspondence Address: WOOD PHILLIPS VAN SANTEN CLARK AND, MORTIMER, 500 WEST MADISON STREET, SUITE 3800, CHICAGO, IL, 60661

(21) Appl. No.: 09/168,513

(22) Filed: Oct. 8, 1998

(51) Int. Cl. H04Q 7/20; H04M 11/00; H04M 1/00; H04B 1/38

(52) U.S. Cl. 455/556

(57) ABSTRACT

A multi-application communication device comprising a wireless communicator configured to provide telecommunications between the device and the public land mobile network. The multi-application communication device includes a processor configured to run at least a current application program having a current application graphical interface and a telephone application having a telephone application graphical interface configured to control the wireless communicator. The communication device also includes a screen and an input device. A plurality of control buttons are displayed on the screen when the wireless communicator is not idle to control the wireless communicator without first changing the current application screen display to the telephone application screen display.

### FIELD OF THE INVENTION

This invention relates to the field of wireless communication devices, and, more specifically, to a communication device that also has computer-like functionality.

### BACKGROUND OF THE INVENTION

Communication devices of today have more functionality than communication devices of science fiction of the past. Today's communication devices have a wireless telephone (also called cell phone or cellular telephone) and a computer-like environment. Such devices perform many of the functions of a pocket computer (organizer, address book, note taking, and e-mail, for example), as well as the functions of a wireless telephone.

One consequence of having multiple, concurrent applications running in a small unit with a correspondingly small video screen is that the user can only view one application's screen display at one time. The user has to close, toggle or at least minimize the currently viewed display in order to switch from one application to another without the aid of a keyboard or a mouse. In this computer-like environment, the telephone application, which controls the wireless telephone, is merely another application. To use the wireless telephone, the user must stop whatever he or she is doing, close or minimize the application display and start the telephone application.

This one-thing-at-a-time (serial) approach to communication devices is not what a user expects when he or she uses a telephone. A user expects a telephone to be instantly accessible. When the telephone starts “ringing,” it can be difficult to hurriedly perform the closing, selecting, opening and answering steps. Further, many people continue to work, take notes, etc., while talking on the telephone. However, such multi-tasking is not possible on today's communicator. Thus, the current, computer-like interface in a communication device is awkward, at best, because it is not a familiar method of using a telephone.

### SUMMARY OF THE INVENTION

In accordance with one aspect of our invention, a multi-application communication device comprises a wireless communicator having a plurality of states configured to provide telecommunication between the device and the public land mobile network. The multi-application communication device also includes a processor configured to manage at least a current application program having a current application screen display and a telephone application having a telephone application screen display. The telephone application is configured to control the wireless communicator. The communication device also includes a screen and an input device. According to this invention, a plurality of telephone control buttons are displayed on the screen when the wireless communication is not idle and are operable in conjunction with the input device to control the state of the communication device without first changing the current application screen display to the telephone application screen display.

In accordance with another aspect of the invention, the communication device further includes a plurality of application programs each having its own graphical user interface wherein the current application is one of the plurality of application programs. Further, the control buttons are configured to present call answering options responsive to receipt of an incoming call, and is configured to continue running the current application program during an active telephone call. The screen and input device may comprise a touch screen or the input device may comprise a keypad. Further, the input device may comprise a stylus or speech recognition.

In accordance with a method aspect of our invention, a method is disclosed for controlling a multi-application communication device having a wireless communicator, a screen, an input device and a processor running a plurality of application programs each having a graphical user interface. The method comprises the steps of defining one of the plurality of application programs as a currently operating application, displaying the screen display for the currently operating application, and defining a location on the screen that is operable in conjunction with the input device to operate the communication device when the telephone application is not the currently operating application.

In accordance with another aspect of this invention, the method further includes the steps of receiving an incoming call, presenting a screen display of options for answering the call and continuing to display the screen display for the currently operating program. The method further includes displaying a telephone access icon on the screen to indicate the location to operate the communications device in response to receipt of a telephone call. Further, the step of displaying the call answering options comprises displaying an answer icon, a divert icon and a reject icon. The call is answered responsive to activation of the answer icon, diverted to for example a voice mail system responsive to the divert icon, and the call is not answered responsive to the reject icon.

### BRIEF DESCRIPTION OF THE DRAWINGS

A more complete understanding of this invention may be obtained from a consideration of the following detailed description in conjunction with the drawings, in which:

FIG. 1 is a block diagram of a multi-application communication device according to an exemplary embodiment of this invention;

FIG. 2 is a sample screen display of the communication device in an idle state;

FIG. 3 is a screen display of the communication device in the incoming call state; and

FIG. 4 is a state diagram of control of the communication device of FIG. 1.

### DETAILED DESCRIPTION

In most computer operating systems, the main screen is considered a “virtual desktop.” Each application opens its own application display on the virtual desktop. The present invention uses the desktop paradigm and adds a communication device (e.g., a telephone) that is always available on the virtual desktop, just as it is on an office desktop. Additionally, as in the desktop analogy, the user may continue working on the current application while using the communication device.

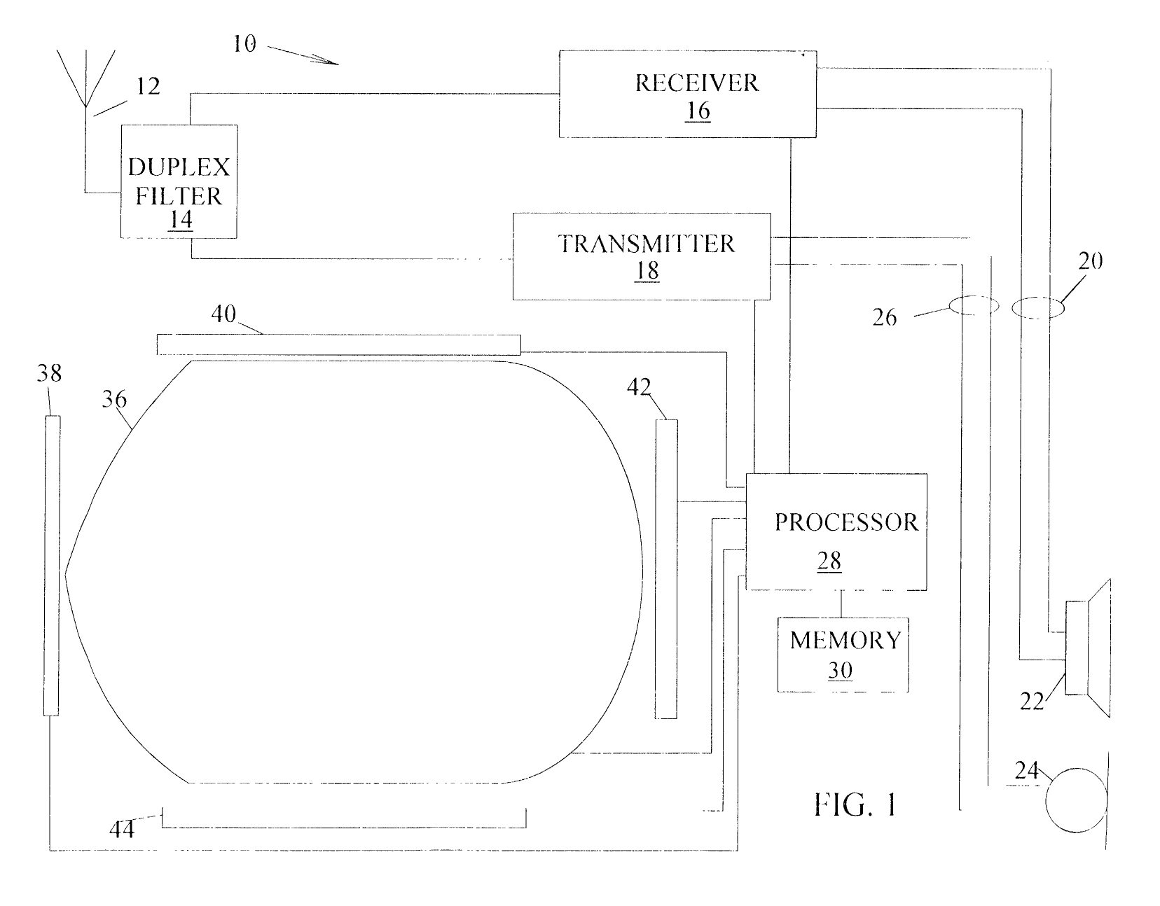

FIG. 1 illustrates a block diagram of a multi-application communication device 10 according to an exemplary embodiment of this invention. The multi-application communication device 10 includes an antenna 12 for sending and receiving radio signals between itself and the public land mobile network (not shown but well known in the art). The antenna 12 is connected to a duplex filter 14, which enables receiver 16 and transmitter 18 to receive and broadcast (respectively) on the same antenna 12. The receiver 16 demodulates, demultiplexes and decodes the radio signals into one or more channels. Such channels include a control channel and a traffic channel for speech or data. The speech or data are delivered over wire pair 20 to speaker 22, or other output device (such as a fax or modem connector).

A microphone 24 receives speech signal input, converts the input into analog electrical signals and delivers the analog electrical signals to transmitter 18 over wire pair 26. The transmitter converts the analog electrical signals into digital data, encodes the data with error detection and correction information and multiplexes this data with control messages from processor 28. The transmitter 18 modulates this combined data stream and broadcasts the resultant radio signal to the public land mobile network through duplex filter 14 and antenna 12.

The processor 28 runs a the plurality of application programs of the multi-application communication device 10 using programs and data stored in memory 30. The processor 28 also controls a video display 36 causing it to display information related to each of the application programs. Such information includes text, symbols, icons and pictures as is known in the art. According to this exemplary embodiment of this invention, the display 36 is a touch screen. To this end, vertical transducer 38 and horizontal transducer 40 emit optical or audio waves to vertical receiver 42 and horizontal receiver 44, respectively. A finger touch on display 36 interrupts the wave flow, whereby processor 28 determines the location of the touch based on the coordinates reported by receiver 42 and 44, as is known in the art. Thus, processor 28 displays various text, icons, etc., on the screen, and runs the application programs according to the coordinates of the touched location.

Of course, a stylus-based input device or speech recognition could be used instead of a touch screen with the invention. Further, a display screen and a separate keyboard or pointing device (such a mouse) may be used, as are all well known in the art.

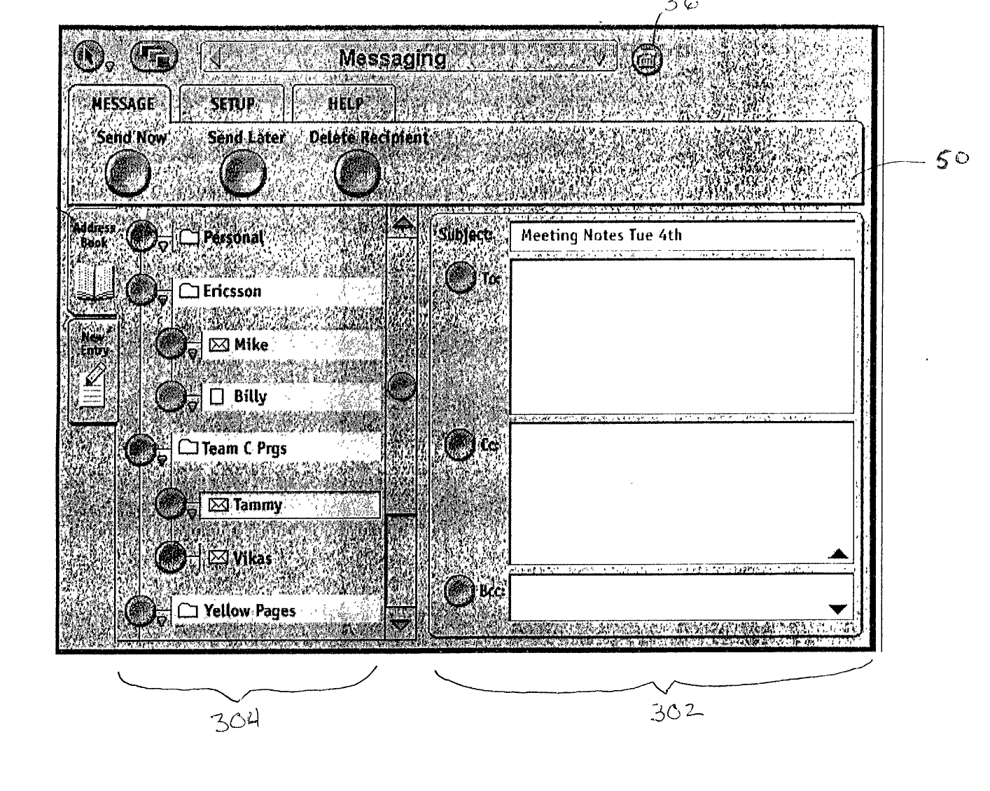

Turning now to FIG. 2 a screen display according to one exemplary embodiment of this invention is shown. An e-mail application display 50 is illustrated on display 36. In the right-hand column 302, the e-mail message header is ready to accept input. In the left-hand column 304, potential recipients are displayed. The upper portion of the e-mail application display 50 includes a box 54 that displays the currently active application. By touching the box 54, the user can change the application. Adjacent to the application box 54 is a telephone icon 56.

In this exemplary embodiment, the wireless telephone is in its idle state. There are no additional buttons by the telephone icon 56. If the user presses telephone icon 56, the telephone application (dialer) is activated. Additionally, placement of the telephone icon 56 adjacent to the application box 54 conserves screen space by occupying otherwise unused space.

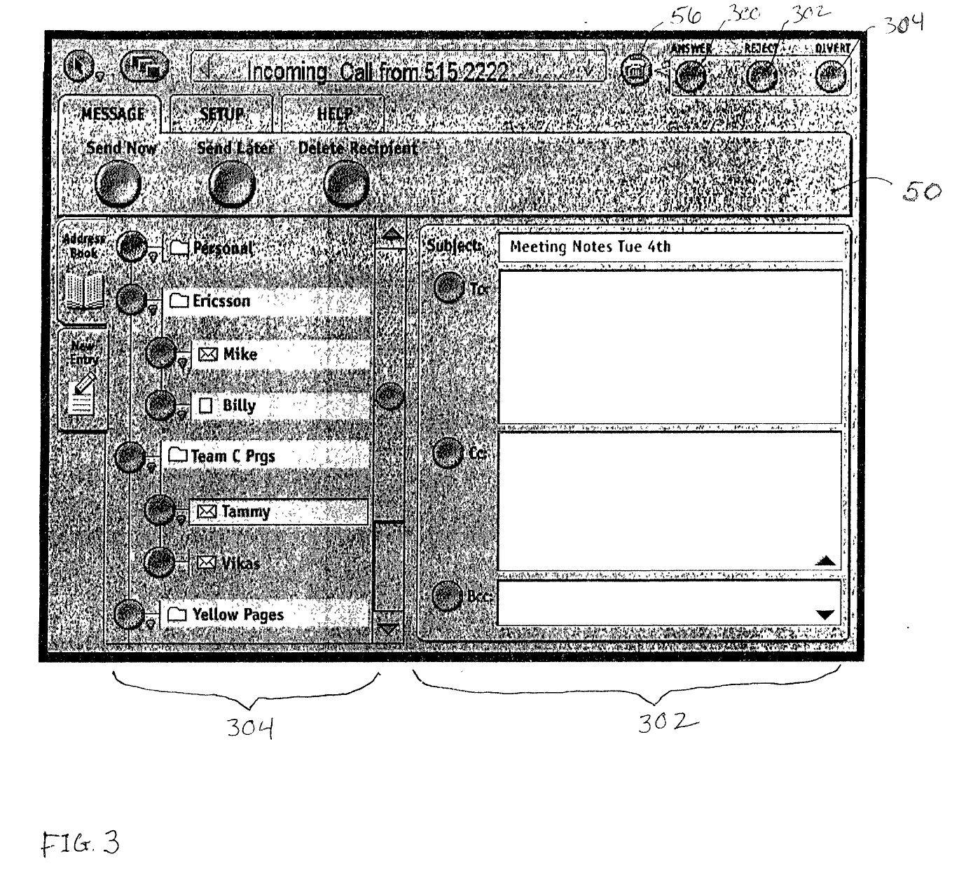

Turning now FIG. 3, a sample graphical user interface is shown when the communication device is in the incoming call state. The current application (e-mail) screen display 50 is still being displayed and the application is active. However, in addition to the telephone icon 56, there are three additional buttons: “answer” 300, “reject” 302 and “divert” 304. (The communication may optional give an audible notification of an incoming call.) The user can select one of the buttons 300, 302 and 304 and then continuing to work on the application. These buttons 300, 302 and 304 provide the user with the ability to answer the call, to reject the call or to divert the call to a preprogrammed location (such as voice mail or a call forwarding number). In this manner, the user does not have to stop or change application programs, as in the prior art.

Whenever the wireless telephone is not idle (that is, receives an incoming call, active on a call, hold, etc.), the possible state changes are display as buttons near telephone icon 56. States and state changes that may appear as buttons are listed in Table 1.

TABLE 1

| State | State | Buttons | |
|---|---|---|---|
| Idle | None | | |
| Incoming Call | Answer | Reject | Divert |
| Active | Hang up | Hold | Transfer |
| Hold | Resume | Hang up | Transfer |

In this manner, the user can intuitively manipulate the telephone in a multi-application communication device without changing applications (unless dialing out).

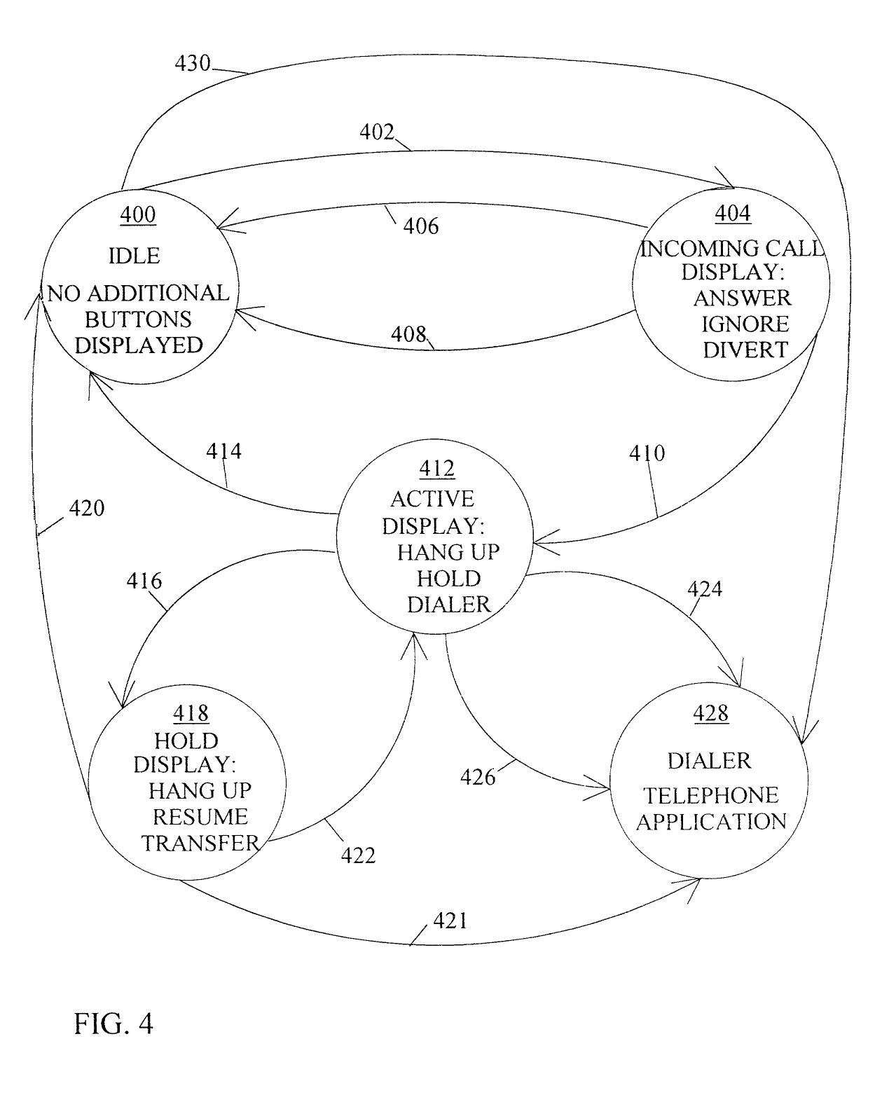

Turning now to FIG. 4 a state diagram is illustrated showing the various states and the controls that are available to the user, without having to change the currently running application. Generally, the wireless telephone is in the idle state. When an incoming call arrives 402, the wireless telephone is not idle and processing moves to the incoming call state 404. As shown in FIG. 3, the incoming controls include answer 300, reject 304 and divert 304.

If the call is answered represented by line 410, in the incoming call state 404, processing moves to the active state 412. The options available from the active state 412 include “end”, line 414, which moves the call back to the idle state 400, and “hold”, line 416, which moves the call into a hold state 418. From the hold state 418, the user can end the call, line 420, transfer the call, line 421, or resume the call, line 422, to the active state 412.

In the active state 412, the user can also receive another incoming call, line 424, or transfer, line 426, the current call. In both cases, the system moves to the dialer state 428 (telephone application). Additionally, the dialer state 428 (telephone application) may be reached by touching the telephone icon in the idle state 430.

It will therefore be apparent that this invention clearly and simply provides a means of providing a multi-application device while still maintaining the communication function in a readily apparent and usable area, thus making confusion less likely and not requiring the user to change to a specific application in order to answer the phone. It is to be understood that the above-described embodiment is to illustrate the principles of this invention, and that those skilled in the art may devise many variations without departing from the scope of the invention. It is, therefore, intended that such variations be included within the scope of the appended claims.

1. A multi-application communication device comprising:
a wireless communicator having a plurality of states configured to provide telecommunications between the device and the public land mobile network;
a processor configured to run at least a current application program having a current application graphical interface and a telephone application having a telephone application graphical interface configured to control the wireless communicator;
a screen configured to display one of said graphical interfaces at a time under the control of the processor;
an input device; and
a plurality of telephone control buttons displayed on the screen when the wireless communicator is not idle operable in conjunction with the input device to control the state of the wireless communicator without first changing the current application graphical interface to the telephone application screen display.

2. The multi-application communication device of claim 1 further including a plurality of application programs each having a graphical interface, wherein said at least a current application program comprises one of said plurality of application programs.

3. The multi-application communication device of claim 1 wherein said control buttons are configured to present call answering options responsive to receipt of an incoming telephone call.

4. The multi-application communication device of claim 3 wherein said processor is configured to continue running said current application program while said communication device is active.

5. The multi-application communication device of claim 1 wherein said screen and said input device comprise a touch screen.

6. The multi-application communication device of claim 1 wherein said input device comprises a keypad.

7. The multi-application communication device of claim 1 wherein said input device comprises a stylus.

8. A method for controlling a multi-application communication device, said communication device comprising a screen, an input device, and a processor running a plurality of application programs each having a screen display and a telephone application having a graphical interface, said method comprising:
defining one of said plurality of application programs as a currently operating application;
displaying the graphical interface for the currently operating program; and
defining a location on the screen that is operable in conjunction with the input device to operate said communication device when the telephone application is not the currently operating application.

9. The method of claim 8 further including the steps of:
receiving an incoming call;
presenting a display of options for answering the call; and
continuing to display the screen display for the currently operating program.

10. The method of claim 8 further including the step of:
displaying a telephone access icon on the screen to indicate the location to operate the communication device.

11. The method of claim 10 further including the step of:
displaying call answering options at the location to operate the communication device responsive to receipt of a telephone call.

12. The method of claim 11 wherein the step of displaying call answering options comprises displaying an answer icon, a divert icon and a reject icon.

13. The method of claim 12 further including the step of:
answering said incoming call responsive to the answer button being input by the user.

14. The method of claim 12 further including the step of:
diverting the incoming call to a voice mail system responsive to the divert button being input by user.

15. The method of claim 12 further including the step of:
rejecting the incoming call responsive to the reject icon being input by the user.
